(19) United States
(12) Patent Application Publication
(10) Pub. No.: US 2008/0313413 A1
(43) Pub. Date: Dec. 18, 2008

(54) Method and Device for Insuring Consistent Memory Contents in Redundant Memory Units

(76) Inventors: Franz Hutner, Sulzemoos (DE); Pavel Peleska, Grafelfing (DE)

Correspondence Address: STAAS & HALSEY LLP, SUITE 700, 1201 NEW YORK AVENUE, N.W., WASHINGTON, DC, 20005, US

(21) Appl. No.: 11/658,840

(22) PCT Filed: Jul. 27, 2004
(86) PCT No.: PCT/EP04/08402

§ 371 Date: Jan. 29, 2007

(51) Int. Cl. G06F 12/16; G06F 13/00

(52) U.S. Cl. 711/162; 711/E12.103

(57) ABSTRACT

In a telecommunications or data processing system having at least one active control unit and at least one redundant passive control unit that are respectively provided with at least one memory unit, the following operations are performed: (a) a mirroring routine is invoked when a virtual memory region in a memory unit of an active control unit, having a memory content that is to be mirrored to a memory unit of the at least one redundant passive control unit, is accessed by writing; (b) during execution of the mirroring routine, the memory content to be written is copied into a memory region in the memory unit of the at least one redundant passive control unit; and (c) the writing access to the active control unit, which has led to the invocation of the mirroring routine, is repeated in the mirroring routine, on another virtual memory region that is imaged onto the same address as the memory region.

### BACKGROUND

Described below are a method and a device for insuring consistent memory contents in redundantly maintained memory units within a telecommunication or, as the case may be, data processing system.

The probability in percentage terms that a hardware defect will occur within a period of one year on a typical processor board consisting of a CPU, chipset, main memory, and peripheral components is in single figures. Telecommunication systems and what are termed data centers typically have a multiplicity of such boards. Systems such as switching centers are typically constructed from up to several hundred such processor boards, as a result of which the probability that any single hardware component will fail during a one-year period becomes very high. Telecommunication systems in particular, but increasingly also data centers, are required to provide a high level of system availability, for example an availability of >99.999% or, as the case may be, a non-availability of a few minutes per year. As it generally takes between 10 minutes and a few hours to replace a processor board and restore service after a hardware defect has occurred, suitable precautionary measures covering the eventuality of a hardware defect at system level have to be taken so that the requirement relating to system availability can be met.

The requirement for availability of the type can basically only be met using redundant system components. Here there is the approach of monitoring redundancy through software measures, with what is termed middleware being employed therefor, or the approach of encapsulating redundancy at hardware level so that this is transparent for the software. The main disadvantage of redundancy monitored by software measures is that only (application) software that has been developed for this particular redundancy scheme can be employed in a system of the type. That considerably limits the range of (application) software that can be used. Moreover, the application software for software redundancy principles is generally expensive and time-consuming to develop and test.

The control software of known switching systems is in particular very extensive (containing up to several million lines of code). The software can therefore only be adapted at very high cost and substantial risk.

Specially developed hardware has therefore hitherto been necessary for switching systems of the type. The hardware then supports the required redundancy so that, should individual hardware modules fail, enough information will be available on the redundant units for uninterrupted continuing operation. What is frequently used therefor is a copying mechanism that always runs automatically in parallel in the background and continuously copies a well-defined part of an active control unit's main memory to a redundant unit's memory (often called a “reflective memory”).

The direct consequence is that the development costs required for switching system controls are very high and the innovation cycle of the controls is usually very long. The reflective memory is also increasingly being made much more difficult to implement on account of the latest optimizations in microprocessor development such as, for example, fast, often also proprietary and protected bus systems and internal caches having a write-back function.

### SUMMARY

A method is described for insuring consistent memory contents in redundantly maintained memory units within a telecommunication or data processing system, having at least one active control unit and at least one redundant passive control unit that are embodied having in each case at least one memory unit, with the following operations being executed:
A mirroring routine will be called if a memory area in a memory unit of the active control unit is write-accessed, which area's memory contents are in the event of memory accessing for writing to be mirrored into a memory unit of the at least one redundant passive control unit,
the cited mirroring routine is called by suitably setting the memory management unit, not by explicitly calling it from the programs being executed,
while the mirroring routine is being executed, the memory contents requiring to be written will be saved to a memory area in the memory unit of the at least one redundant passive control unit, and
write accessing of the active control unit, which accessing caused the mirroring routine to be called, is performed again in the mirroring routine on another virtual memory area that has been mapped onto the same physical address as the memory area writing to which caused the mirroring routine to be called.

The main advantage is that programs having no advance provisioning for redundancy and otherwise providing a failsafe, highly available system only in conjunction with special hardware can run on virtually any commercially available processor platform and still achieve the same high level of availability as complex special solutions.

In the future it will thus also be possible to introduce new generations of control computers at no great expense, which is to say the innovation cycles can become much shorter.

The dynamic disadvantages due to calling of the mirroring routine, also called a trap routine, are mitigated in various ways:
Trap routines will only be triggered when pages are written to the data content of which actually has to be mirrored onto the redundant unit. Many write cycles for temporary or local data will hence be unaffected and so continue to run with maximum performance. Nor will any read accessing be retarded.
The trap routine's function can be implemented as a functional sequence in micro-code form, which measure will reduce the dynamic losses occurring when the trap routine is launched and quitted.
Many processors offer a special interface for co-processors. After initiation by the memory management unit, duplicating of memory access to the redundant and active page could also be implemented in hardware by a co-processor. That will eliminate the dynamic disadvantage of a trap routine as well as of a micro-code routine.

Any changes in the memory of the active unit will be mirrored onto the redundant unit by a trap routine during ongoing operation. It will then be possible in the event of a fault to change over to the redundant unit with no loss of information.

The method is, however, only adequate for mirroring ongoing changes in the memory to the redundant unit. If, though, a unit is replaced during operation owing to, for example, a defect, then the identical memory status of the active board will no longer be attained thereby. In that case it will also be necessary to convey all static data, which is to say data that is not further changed during operation, to the replaced redundant unit.

An advantageous embodiment is accordingly to be found in a method corresponding to the following:
once-only, complete copying of the memory contents of the active control unit's memory unit to the memory area in the at least one redundant passive control unit's memory unit by a copying routine after the passive control unit has been replaced or powered on,
incrementing the memory address requiring to be copied in a global variable at each copying operation,
when the first cited mirroring routine is executed, comparing the memory address of the memory area requiring to be written to with the memory address in the global variable,
delaying execution of the first cited copying routine if the memory addresses tally when compared.

The copying of the active unit's static memory contents to the redundant unit is not inconsequential because copying has to take place during the active unit's ongoing operation. So data may be changed precisely while being conveyed through the copying operation to the redundant unit. Copying is customarily implemented through loading into a processor register and writing back. The active unit may then change an item of data precisely at an instant after it has been loaded into the processor register but before it could be stored on the redundant unit. The consequently possible inconsistency of data on the active and redundant unit has hitherto been ruled out in known systems by suitable, proprietary hardware circuitry.

However, the need for special hardware precludes the use of standard modules of the kind available on the market. That solution thus necessitates a high level of development expenditure, which can be eliminated by the software implementation proposed in the following.

The main advantage is that systems consisting of standard modules can be synchronized during ongoing operation without any special redundancy support provided by hardware, and can thus be restored to a redundant mode of operation with a possibility of fast changeover also after a unit has been replaced.

In standard operation, when memory consistency has been achieved between the active and redundant unit the dynamic overhead due to testing of the memory area variables is negligible.

A control unit may be used for implementing the method having a virtual memory unit (VSP) and a physical memory unit (aPS) whose memory contents can, in the event of memory accessing for writing, be mirrored into a memory unit of at least one further redundant passive control unit (rSt), and which
calls a mirroring routine in order, in the event of memory accessing of the memory area for writing, to duplicate the memory contents into a memory area in the at least one redundant passive control unit's memory unit, and
allows the write-accessing operation that caused the mirroring routine to be called to be performed on another virtual memory area that has been mapped onto the same physical address as the memory area writing to which caused the mirroring routine to be called.

### BRIEF DESCRIPTION OF THE DRAWINGS

These and other objects and advantages will become more apparent and more readily appreciated from the following description of the exemplary embodiments, taken in conjunction with the accompanying drawings of in which:

FIG. 1 and FIG. 2 show a possible architecture of the active and redundant control unit.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

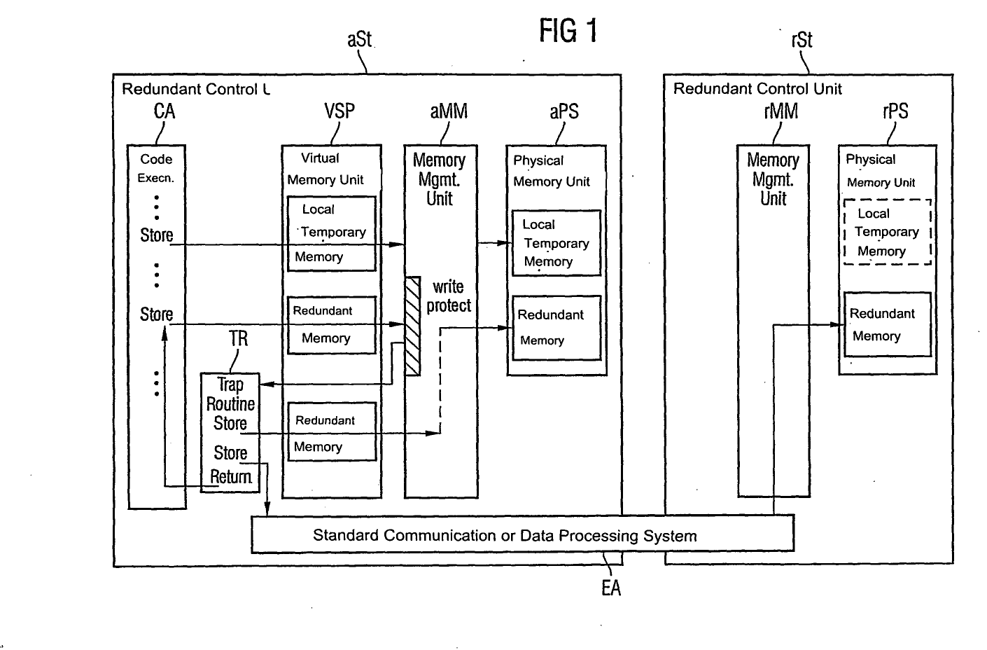

FIG. 1 shows an architecture of an active control unit within a telecommunication system. What are illustrated are an active processor operation exhibiting the flow of code sequences CA, what is termed a trap routine TR, a memory unit having a virtual memory area VSP, a memory control unit aMM, and a memory unit having a physical memory area aPS that communicate with each other (indicated by the arrowed lines). Also illustrated are a redundant control unit, which includes a redundant memory unit rPS, and an input/output system EA via which the active control unit communicates with the redundant control unit.

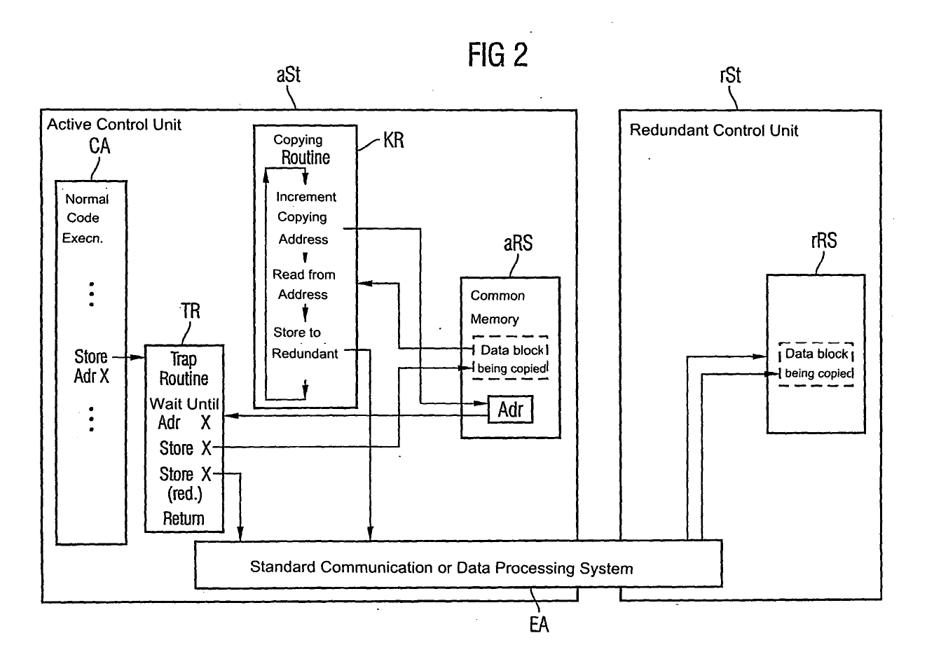

Virtually the same architectural units are illustrated in FIG. 2. The active control unit aST additionally has a further copying routine KR. Redundant memory areas of the active and the redundant control unit are identified by aRS and rRS, respectively.

### FIG. 1:

According to the proposed method, redundant units are no longer provided with the current copy of the active unit's memory contents by special hardware.

Functions of the memory management unit, which is present in all relevant processors, are instead used to be able, at runtime, to check each time the active control unit AST is accessed for storing whether a copy has to be created on the redundant control unit rST of the item of data requiring to be written.

That is possible by setting the attributes for each memory page (typically 4 kilobytes) to ‘write protected’ or ‘read only’.

If, accordingly, a process write-accesses a memory area of the type in the memory control unit aMM, then the command execution CA will be interrupted and a trap routine TR called.

The trap routine then analyzes the storage command and insures that the same item of data will be written to the same memory address of the redundant memory unit. That can be supported by suitable standard hardware such as, for example, PCI Express.

The local write operation on the active control unit also has to be performed. The most efficient way to do this is by a write cycle to a non-protected memory page in the virtual address space of the virtual memory unit VSP that is mapped to the same physical page in the physical memory unit aPS as the write-protected one. That is made possible by all known memory control units aMM.

When both the local memory and the memory unit rPS of the redundant control unit have been write-accessed, the trap routine returns to the standard command execution behind the storage command (that was executed in the trap routine) and the normal program flow will be resumed.

To improve the dynamic characteristics, the described trap routine functionality can also be implemented in micro-code form in the processor. In that case, owing to the write protection flag of the memory page in the memory control unit aMM a trap routine would not be triggered but, instead, the corresponding functional sequence that duplicates write-accessing of the redundant control unit would be initiated directly in micro-code form. The dynamic loss due to launching and quitting the trap routine will be reduced thereby.

As a further optimization, a co-processor can be connected to the processor which, after initiation by the memory control unit aMM, will provide for duplicating write-accessing. Both the trap routine and a micro-code routine can as a result be dispensed with.

### FIG. 2:

On the active control unit aSt a software routine or, as the case may be, a copying routine KR continuously copies the memory to the redundant control unit rSt. That takes place in small, fixed units (the size of a cache line, for instance). Active operation takes place simultaneously on all the active control unit's other processors. Therefrom ensues the continual calling of trap routines TR that mirror current changes in the memory contents to the redundant control unit rSt.

To avoid inconsistencies with the data mirrored by the trap routines, the base address of the data block being copied (a cache line, for example) is stored in a global variable. The global variable is located in the active control unit's common memory aRS; all the active unit's processors have read access (except for the copying process, which updates the base address for each data block requiring to be copied).

If the trap routine is then called on any processor when the memory is being write-accessed, the global variable having the base address must be compared in the trap routine with the current write address. If the addresses are different (which is to say that write accessing is directed at an area not being copied at that instant), then the trap routine can run normally and write accessing will be mirrored to the redundant control unit's page. If it is determined during the trap routine that accessing is directed at the data block being mirrored onto the redundant control unit's memory, then the trap routine will keep polling the global variable until the recopying operation has finished and the global variable has been updated to the next data block. The trap routine will then likewise be able to be completed normally.

Impacts on dynamic performance: Polling during the trap routine is a seldom occurrence (necessary only when precisely the data block currently being copied is being written to), and polling does not take long (it does not take long to copy such a small area). Interrogating the global variable does, though, always produce an overhead in the trap routine owing to the necessary address comparison. The additional runtime will, however, be short during standard operation if the memory is not performing a copying operation. In that case the global variable will, if not changed for a long time, be safely in the cache (owing to the frequency of the trap) when the trap routine is called, and the comparison will result in only a slight runtime overhead. The overhead will be more critical if the recopying process is running in parallel, with the variable then being continually changed and no current copy being present in the cache. In that case a storage access to the memory must be executed as a trap routine overhead for the purpose of reading in the address stored in the global variable.

This principle places no special requirements on the hardware or software of a redundant system: It is necessary only to integrate the relevant routine for recopying the memory contents with the control via a global variable having the address that is currently to be copied.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-7. (canceled)

8. A method for ensuring consistent memory contents in redundantly maintained memory units within a telecommunication or data processing system, having at least one active control unit and at least one redundant passive control unit that each have at least one memory unit, comprising:
calling, by a programmed memory management unit, not by explicitly calling from programs being executed, a mirroring routine if a memory area in a physical memory unit of an active control unit is write-accessed, the memory area having memory contents that are, in the event of memory accessing for writing, to be copied into a redundant memory unit of the at least one redundant passive control unit;
copying, by execution of the mirroring routine, the memory contents of the memory area in the physical memory unit into a corresponding memory area in the redundant memory unit of the at least one redundant passive control unit; and
performing write accessing to a virtual memory area in the active control unit that has been mapped onto a virtual address matching a writing address of the memory area in the physical memory unit for which the mirroring routine was called upon being write-accessed.

9. The method as claimed in claim 8, wherein the virtual memory area has been designated as write-protected prior to the memory area in the physical memory unit being write-accessed.

10. The method as claimed in claim 9, further comprising:
once-only, complete copying of all memory contents of the physical memory unit of the active control unit to the redundant memory unit of the at least one redundant passive control unit by a copying routine when the redundant control unit is initially powered on;
incrementing, for each copying operation, a copying memory address stored in a global variable;
when the mirroring routine is executed, comparing the writing address of the memory area being written to in the physical memory unit with the copying memory address in the global variable; and
delaying execution of the mirroring routine if the copying and writing memory addresses match.

11. The method as claimed in claim 10, further comprising continuing the mirroring routine when the copying and writing memory addresses are different.

12. The method as claimed in claim 11, wherein the mirroring routine is implemented as a functional sequence in microprocessor code.

13. The method as claimed in claim 12, wherein the mirroring routine is executed by a co-processor.

14. An active control unit for implementing a method for ensuring consistent memory contents in redundantly maintained memory units within a telecommunication or data processing system also having at least one redundant passive control unit with at least one redundant memory unit, comprising:
a virtual memory unit;
a physical memory unit;
means for calling a mirroring routine, when a write-accessing operation is performed on a memory area of the physical memory unit, to duplicate the memory contents into the at least one redundant passive control unit; and
means for allowing the write-accessing operation that caused the mirroring routine to be called to be performed on a virtual memory area that has been mapped onto a same address as the memory area in the physical memory which caused the mirroring routine to be called.
